(19) United States
(12) Patent Application Publication
(10) Pub. No.: US 2026/0129486 A1
(43) Pub. Date: May 7, 2026

(54) METHODS, ARCHITECTURES, APPARATUSES AND SYSTEMS FOR REPORTING LOGGED SENSING MEASUREMENT

(71) Applicant: InterDigital Patent Holdings, Inc., Wilmington, DE (US)

(72) Inventors: Jongwoo Hong, New York, NY (US); Fumihiro Hasegawa, Westmount (CA); Ghyslain Pelletier, Montreal (CA); Paul Marinier, Brossard (CA); Moon IL Lee, Melville, NY (US); Remun Koirala, London (GB); Arman Shojaeifard, London (GB); Benoit Pelletier, Roxboro (CA)

(21) Appl. No.: 18/936,853

(22) Filed: Nov. 4, 2024

(51) Int. Cl. H04W 24/10; H04W 64/00

(52) U.S. Cl. CPC H04W 24/10; H04W 64/003

(57) ABSTRACT

Methods and systems are provided for reporting logged sensing measurements using a wireless transmit/receive unit (WTRU). The WTRU receives, from a network, a logged sensing configuration comprising measurement configuration information and reporting condition information for a logged sensing task, wherein the reporting condition information comprises a reporting condition and an indication of an uplink signal to use for reporting. The WTRU performs sensing measurements based on the measurement configuration information to generate a sensing measurement result. The WTRU; in response to determining that the reporting condition is satisfied, reports, to the network using the uplink signal when a radio resource control (RCC) connection is not established between the WTRU and the network, a reporting indication based on the sensing measurement result.

### BACKGROUND

The present disclosure is generally directed to the fields of communications, software and encoding, including, for example, to methods, architectures, apparatuses, systems related to reporting logged sensing measurement.

### SUMMARY

This disclosure relates reporting logged sensing measurements. A wireless transmit/receive unit (WTRU) receives from a network, a logged sensing measurement configuration and a reporting configuration associated with a logged sensing task. The WTRU performs measurements based on the measurement configuration and upon identifying a trigger, reports the measurement configuration to the network. The sensing task may be a semi-static sensing or a dynamic sensing.

In certain representative embodiments, methods and systems are provided for reporting a logged sensing measurement. The methods and systems may include a WTRU receiving, from a network, a logged sensing configuration comprising measurement configuration information and reporting condition information for a logged sensing task, wherein the reporting information comprises a reporting condition and an indication of an uplink signal to use for reporting. The methods and systems may further include performing sensing measurements based on the measurement configuration information to generate a sensing measurement result. The methods and systems may further include determining whether the reporting condition is satisfied. The methods and systems may further include the WTRU, in response to determining that the reporting condition is satisfied, reporting, to the network using the uplink signal when a radio resource control (RCC) connection is not established between the WTRU and the network, a reporting indication based on the sensing measurement result.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a sensing operation of a WTRU according to one or more embodiments;

FIG. 3 illustrates an example of a 5G System Assisted Automotive maneuvering and navigation according to one or more embodiments;

FIG. 4 illustrates a procedure for MDT measurement configuration for Logged MDT according to one or more embodiments;

FIG. 5 illustrates an example of logged sensing measurement according to one or more embodiments;

FIG. 6 illustrates a procedure for reporting logged sensing measurements according to one or more embodiments;

FIG. 7 illustrates a logged sensing measurement and reporting procedure 700 based on conditions according to one or more embodiments;

FIG. 8 illustrates a logged sensing measurement and reporting procedure based on a network request according to one or more embodiments; and

FIG. 9 illustrates a method for reporting logged sensing measurement according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

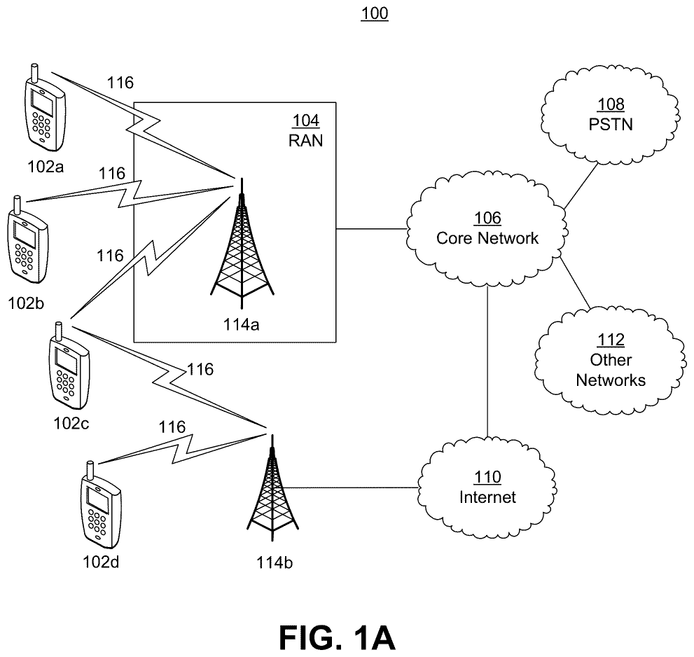

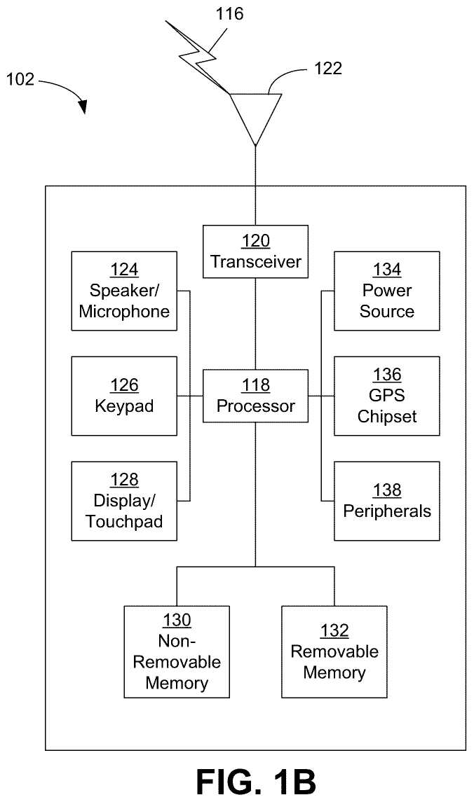

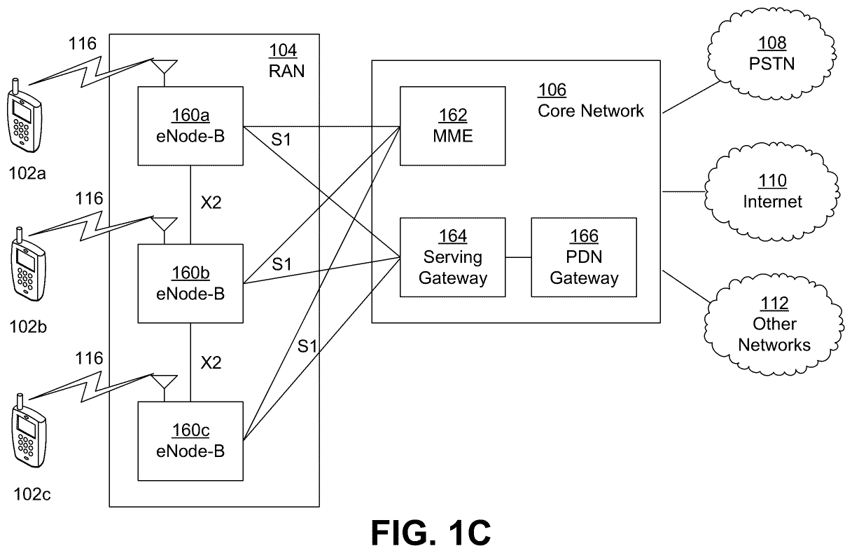

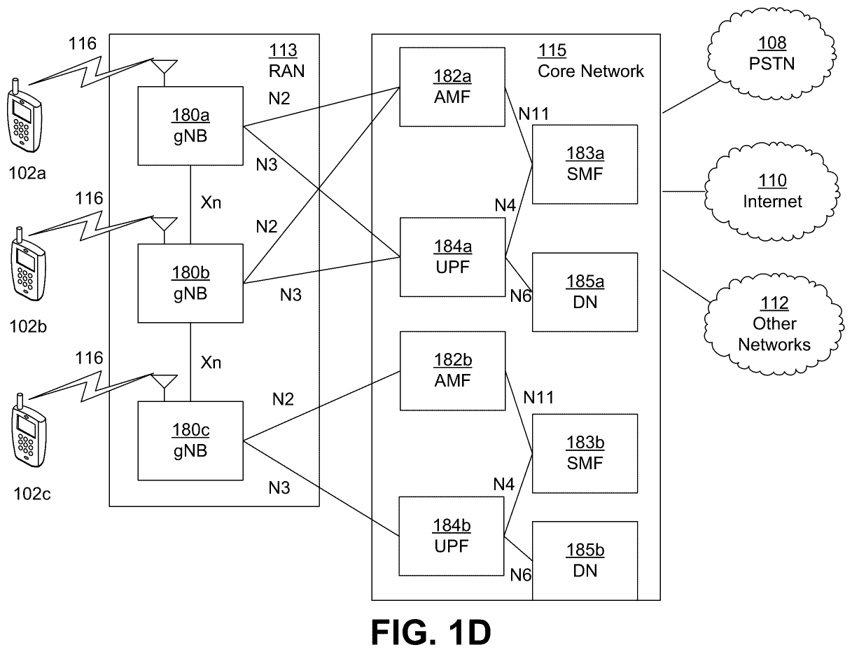

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11c DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In certain representative embodiments, wireless sensing (e.g., 5G/6G wireless sensing) may be utilized as a technology enabler to acquire information about characteristics of the environment and/or objects within the environment, that uses radio waves to determine the distance (range), angle, or instantaneous linear velocity of objects, etc. The wireless sensing service may rely on analyzing the transmissions, reflections, and scattering of wireless sensing signals.

In certain representative embodiments, integrated sensing and communication technology for enabling new services and use cases for various industries are provided. Wireless sensing service, as part of a cellular network may provide new possibilities for enhanced usage of the telecommunication infrastructure in areas of object detection and tracking, environment monitoring and human motion monitoring. This may provide input to various verticals-unmanned aerial vehicles (UAVs), smart home, Vehicle-to-Everything (V2X), or factories.

In certain representative embodiments, the use cases may cover a wide range of applications, including: object and intruder detection for smart home, on a highway, for railways, for factory, for predefined secure areas around critical infrastructure; collision avoidance and trajectory tracking of UAVs, vehicles, Automated Guided Vehicles (AGVs); automotive maneuvering and navigation; public safety search and rescue; rainfall monitoring and flooding; health and sports monitoring.

In certain representative embodiments, use cases may be include wireless sensing and some of the use cases may include non-3rd Generation Partnership Project (3GPP) type sensors (e.g. Radar, camera). Wireless sensing service may bring challenges related to confidentiality and privacy. There may be a need to protect the sensing data from unauthorized access, interception and eavesdropping, but also to make sure there is compliance with regulation and user awareness. Based on the use cases, system support (e.g., 5G/6G system support) of different use cases and service requirements for Integrated Sensing and Communication are provided.

In certain representative embodiments, sensing in smart homes is provided. Sensing in a smart home may be an example of a typical scenario of indoor/local-area sensing. Considering people spend most of their lifetime indoors, improving the user experience for an indoor scenario is important. Various WTRUs, e.g. a wearable device, a sensor, a smart phone and/or a customer premise equipment (CPE), may be deployed at home. In order to enjoy more comfortable and convenient indoor life, the various devices may be connected via wireless signals to build a smart home platform.

In certain representative embodiments, in addition to communication purposes, wireless signals may also be used for sensing, e.g., monitoring the home environment continuously.

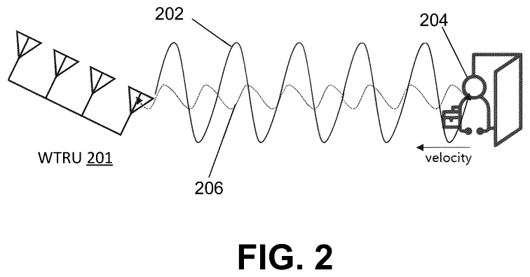

In certain representative embodiments, intruder detection in a smart home scenario is provided. FIG. 2 illustrates an example of a sensing operation of a WTRU 201 according to one or more embodiments. For intruder detection due to the activities of indoor object or human, the signal (e.g., a 3GPP signal) measured by a WTRU or network may be influenced. By analysing and collecting the sensing information such as Doppler frequency shift, amplitude change and phase change, the behaviour of indoor object or human may be detected as shown in FIG. 2. The WTRU 201 may transmit a sensing signal 202 which is reflected by a new reflector 204 (i.e. a moving person with a velocity). A reflected signal 206 may vary in at least one of frequency, phase, amplitude. or time of flight (ToF) from the sensing signal 202.

In certain representative embodiments, to support smart transportation and autonomous driving, more vehicle and devices may be equipped with sensing technologies. In some embodiments, cameras, Radar, and Lidar systems may be the most used sensors by the automotive industry to maintain the perception for autonomous vehicles at various levels of autonomy. Accurate sensing results may be crucial to enable the safe and reliable control of the vehicles.

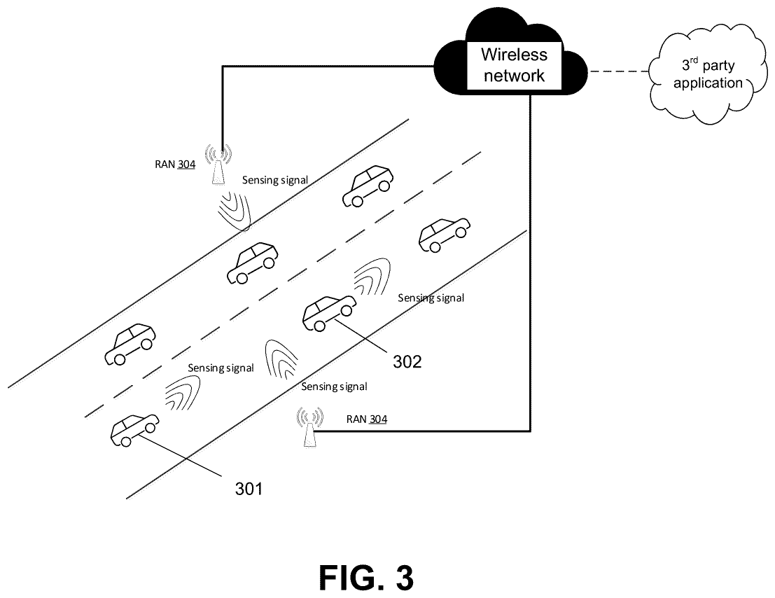

In certain representative embodiments, due to the mounting position of the sensors (e.g., 3GPP based sensors) information collected from a single vehicle's sensors may not be sufficient or accurate enough to satisfy the advanced automotive use cases, e.g., autonomous driving, coordinated maneuver, etc. FIG. 3 illustrates an example of a network (i.e. 5G) system assisted automotive maneuvering and navigation according to one or more embodiments. The system may coordinate sensing to get sensing data from various sources and generate sensing results which may be consumed at the vehicle and used for the vehicular control and driver assistance, e.g., feed into the Automated Driving System (ADS) in the car. The network sensing data (i.e. 3GPP network sensing) collected by the WTRU may be sent alongside relevant sensing information to other sensing entities (including other vehicles, roadside units, and network) for further processing (if required) before sharing with a third-party application as shown in FIG. 3.

The network facilitated NR based sensing described above may significantly improve the sensing reliability and quality, enabling new and advanced automotive use cases.

In certain representative embodiments, a first vehicle 301 and a second vehicle 302 may be equipped with wireless-based (i.e. 3GPP-based) sensing technology. Non-wireless (i.e. non-3GPP) sensors such as radar, camera and lidar sensors may also be available in the vehicles. Additionally, the vehicles 301 and 302 may be capable of wireless (i.e. 5G) communications, including direct communication with other vehicles, communication with 5G system via RAN entities 304.

In certain representative embodiments, a wireless (i.e. 5G) system assisted coordination of sensing service may comprise one or more of the following steps:

Step 1 (Network provides configurations and policies): When a first vehicle 301 registers for 3GPP sensing service, the network 304 may provide policies and configurations to enable WTRUs take appropriate actions during sensing e.g., obtaining 3GPP sensing data from other WTRUs/RAN entities. In some embodiments, the policies provided by network may provide guidance for the discovery WTRUs/RAN entities with appropriate radio (i.e. New Radio Reference Frequency NR RF) sensing capabilities, when to trigger requests, when to stop sending requests, messaging formats, the communication configurations (such as which 5G communication mode to use and under which conditions), the sensing configurations (such as which role i.e. transmitter/receiver, to use by a particular node for a particular sensing task, etc., These polices and configurations may be updated frequently by the network based on e.g., network conditions, mobility pattern, etc.

Step 2 (The first vehicle 301 may determine its sensors are blocked): the first vehicle's sensor(s) may be blocked by a second vehicle 302, and may not adequately detect its surroundings (e.g., detect if there is another vehicle in front). This may result in the vehicle miscalculating the needed distance to stop before a traffic light. In other cases, the second vehicle 302 may also reduce the valid sensing region and result in misdetection of incoming vehicles size or shape, especially near intersections. The sensing results may not fully satisfy the autonomous driving needs and requirement.

Step 3 (the first vehicle 301 may recognize need for sensing inputs): Due to unsatisfactory autonomous driving needs and requirements, the WTRU in the first vehicle 301 may be notified that its sensors are blocked and needs wireless (i.e. 5G) system assistance for coordination of the sensing service.

Step 4 (the first vehicle 301 may discover the second vehicle 302): With the policies and configurations provided by the wireless system, the first vehicle 301 may search for neighbouring WTRUs/RAN entities or ask the network to provide recommendations for WTRUs/RAN entities (e.g. considering the current network conditions in the target sensing area) and their wireless (i.e. 3GPP NR RF) sensing capabilities (e.g., if WTRU/RAN entity may support sensing service). This information may be used to discover other vehicles and RAN entities with wireless (i.e. 3GPP NR RF) sensors that can support sensing in the area. In this embodiment, the first vehicle 301 discovered the second vehicle 302 which may be useful in providing sensing inputs.

Step 5 (the first vehicle 301 may connects to the second vehicle 302): the first vehicle 301 may then establish wireless (5G) communication connection with the second vehicle 302 and/or RAN entities. The most suitable 5G communication mode (e.g., broadcast, unicast, etc) may be determined by the first vehicle 301 based on wireless (i.e. 5G) system configuration and policies.

Step 6 (the first vehicle 301 may request sensing info from the second vehicle 302). The request may indicate the information needed to perform sensing, e.g., the additional region to be covered, additional sensing target, synchronization info, etc.

Step 7 (the second vehicle 302 may send sensing results/wireless (i.e. 3GPP) sensing data to the first vehicle 301) Based on the information provided by the first vehicle; the second vehicle 302 may send the first vehicle 301 wireless (i.e. 3GPP) sensing data identifying objects in its surroundings. It is important to note that when wireless sensing data is shared between the second vehicle 302 and the first vehicle 301, it is expected to be performed in compliance with operator policy on the use of the operator resources (e.g., licensed/unlicensed spectrum).

Step 8a (the first vehicle 301 may process 3GPP sensing data locally) Based on the fact that the first vehicle 301 has non-3GPP sensors (e.g., camera, Lidar), the first vehicle 301 may combine the 3GPP sensing data from the second vehicle 302 with other sensors.

Step 8b (The 5G System expose sensing results to third-party application) Additionally or alternatively the first vehicle 301 may share sensing results and non-3GPP sensing data from the camera and Lidar within the wireless (i.e. 5G) system and then it is exposed by the 5G System to a third-party application server for combination by the third-party. It is important to note that contextual information is information forwarded alongside the sensing results which provide context to the conditions under which the sensing results were derived. This contextual information can be used in scenarios where the sensing result is to be combined with data from other sources. It should also be noted that in case contextual information is required, this information may be shared with the appropriate consent, permissions and subject to operator policy.

In certain representative embodiments, a Downlink-Reference Signal (DL-RS) configuration may contain at least one of the following parameters: number of symbols, transmission power, number of DL-RS resources included in DL-RS resource set, muting pattern for DL-RS (for example, the muting pattern may be expressed via a bitmap), periodicity, type of DL-RS (e.g., periodic, semi-persistent, or aperiodic), slot offset for periodic transmission for DL-RS, vertical shift of DL-RS pattern in the frequency domain, time gap during repetition, repetition factor, RE (resource element) offset, comb pattern, comb size, spatial relation (e.g., with respect to other DL-RSs or Uplink Reference Signal (UL RS) such as Sounding Reference Signal (SRS) for positioning purpose), Quasi co-location (QCL) information (e.g., QCL target, QCL source) for DL-RS, number of Transmission/Reception Points (TRPs), Absolute Radio-Frequency Channel Number (ARFCN), subcarrier spacing, expected Reference Signal time difference (RSTD), uncertainty in expected RSTD, start Physical Resource Block (PRB), bandwidth, Bandwidth Part (BWP) ID, number of frequency layers, start/end time for DL-RS transmission, on/off indicator for DL-RS, TRP ID, DL-RS ID, cell ID, global cell ID, or applicable time window. The WTRU may apply a DL-RS configuration under a condition that the current time is within the applicable time window. “ID” may be used interchangeably with “index”. Examples of DL-RS may be Channel State Information-Reference Signal (CSI-RS), Phase Tracking-Reference Signal (PTRS), Positioning Reference Signal (PRS), Tracking Reference Signal (TRS), and Synchronization Signal Block (SSB).

In certain representative embodiments, UL-RS or SRS configuration may include at least one of: resource ID; comb offset values, cyclic shift values; start position in the frequency domain; number of UL-RS symbols; shift in the frequency domain for UL-RS; frequency hopping pattern; type of UL-RS (e.g., aperiodic, semi-persistent or periodic); sequence ID used to generate UL-RS, or other IDs used to generate UL-RS sequence; spatial relation information, indicating which reference signal (e.g., DL RS, UL RS, CSI-RS, SRS, Demodulation Reference Signal (DM-RS)) or SSB (e.g., SSB ID, cell ID of the SSB) the UL-RS is related to spatially where the UL-RS and DL RS may be aligned spatially; QCL information (e.g., a QCL relationship between UL-RS and other reference signals or SSB); QCL type (e.g., QCL type A, QCL type B, QCL type C, QCL type D); resource set ID; list of UL-RS resources in the resource set; transmission power related information; pathloss reference information which may contain index for SSB, CSI-RS or DL-RS; periodicity of UL-RS transmission; and/or spatial information such as spatial direction information of UL-RS transmission (e.g., beam information, angles of transmission), or spatial direction information of DL RS reception (e.g., beam ID used to receive DL RS, angle of arrival). “ID” may be used interchangeably with “index”. Examples of UL-RS may be SRS and SRS for positioning purpose.

In certain representative embodiments, a sensing configuration may consist of one or more DL-RS or UL-RS configurations. A sensing configuration may consist of measurement or reporting related configurations (e.g., periodicity of measurement or reporting, measurement or reporting trigger conditions, content of the measurement). A sensing configuration may consist of a combination of RS configurations, measurement and/or reporting configurations.

In certain representative embodiments, support of Logged Minimization of Drive-Tests (MDT) may comply with the principles for IDLE and INACTIVE state measurements in the WTRU, and principles for IDLE and CONNECTED mode Multimedia Broadcast Multicast System Single Frequency Network (MBSFN) measurements in the WTRU.

In certain representative embodiments, the established principles may result in different logged information in different WTRUs.

Furthermore, measurement logging is differentiated based on WTRU states in idle mode i.e. camped normally, any cell selection or camped on any cell. The WTRU may perform measurement logging in “camped normally” state and “any cell selection” state. In “camped on any cell” state the WTRU may not be required to perform MDT measurement logging (including time and location information).

For Logged MDT, the configuration may be done in cells of the same RAT type. However, measurements included in the logged MDT report may comprise of measurements from the same RAT type (serving cell measurements, intra-frequency and inter-frequency neighbor cell measurements) and different RAT types (inter-RAT neighbor cell measurements).

In certain representative embodiments, logging of MBSFN measurements may be applicable to E-UTRA.

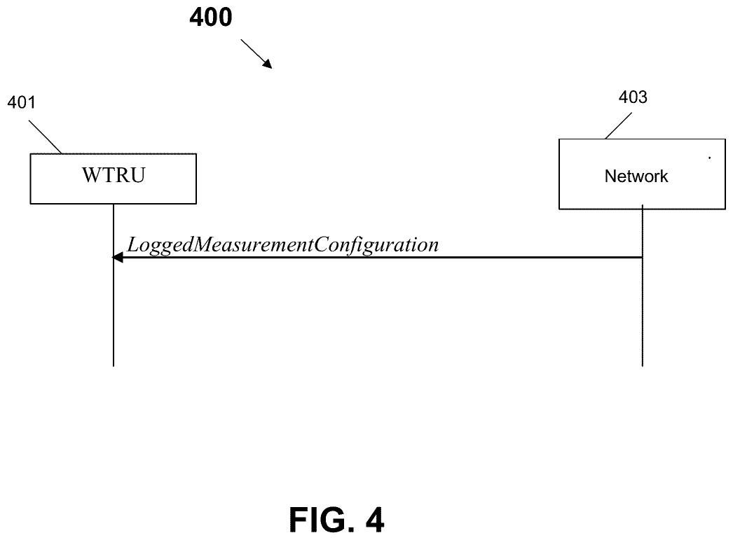

FIG. 4 illustrates a procedure 400 for MDT measurement configuration for Logged MDT according to some embodiments. Logged MDT measurements may be configured with an MDT Measurement Configuration procedure, as shown in FIG. 4.

A Network 403 may initiate the procedure to a WTUR 401 in RRC Connected by sending LoggedMeasurementConfiguration message, which may be used to transfer configuration parameters for Logged MDT. This may be a unidirectional RRC signalling procedure.

A release operation for logged measurement configuration in the WTRU 401 may be realized by configuration replacement when the configuration is overwritten or by configuration clearance in case a duration timer stopping or expiration condition is met.

In certain representative embodiments, a WTRU may be configured to perform Logged MDT downlink pilot strength measurements that indicate the availability of Logged MDT measurements, by means of a one bit, in RRCConnectionSetupComplete or RRCSetupComplete or RRCConnectionResumeComplete or RRCResumeComplete message during connection establishment. Furthermore, the indicator (possibly updated) may be provided within: Evolved Universal Terrestrial Radio Access Network (E-UTRAN) handover and re-establishment; UTRAN procedures involving the change of Serving RNC (SRNC) (SRNC relocation), CELL UPDATE, URA UPDATE messages as well as MEASUREMENT REPORT message in case of state transition to CELL_FACH without CELL UPDATE; NR re-establishment, reconfiguration.

The WTRU may include the indication in one of these messages at every transition to RRC Connected mode even though the logging period has not ended, upon connection to RAT which configured the WTRU to perform Logged MDT measurements and RPLMN which is equal to a PLMN in the MDT PLMN list or currently registered SNPN whose identity is in the stored SNPN identities.

In certain representative embodiments, a WTRU configured to perform Logged MDT MBSFN measurements may indicate the availability of Logged MDT MBSFN measurements, by means of an indicator, in RRCConnectionSetupComplete message during connection establishment. The indicator (possibly updated) may be provided within E-UTRAN also at handover and re-establishment, except when the logged measurement configuration is active in CONNECTED mode, i.e. except when the logging campaign is still ongoing.

In certain representative embodiments, a WTRU configured to perform Logged MDT WLAN measurements may indicate the availability of Logged MDT WLAN measurements, by means of an indicator, in RRCConnectionSetupComplete message or RRCConnectionResumeComplete message during connection establishment. Furthermore, the indicator may be included in some uplink RRC messages, i.e., RRCConnectionReconfigurationComplete message, RRCConnectionReestablishmentComplete message, or UEInformationResponse message, at every transition to RRC Connected mode even though the logging period has not ended.

In certain representative embodiments, a WTRU configured to perform Logged MDT Bluetooth measurements may indicate the availability of Logged MDT Bluetooth measurements, by means of an indicator, in RRCConnectionSetupComplete message or RRCConnectionResumeComplete message during connection establishment. Furthermore, the indicator may be included in some uplink RRC messages, i.e., RRCConnectionReconfigurationComplete message, RRCConnectionReestablishmentComplete message, or UEInformationResponse message, at every transition to RRC Connected mode even though the logging period has not ended.

In certain representative embodiments, a WTRU configured to perform Logged MDT WLAN measurements may indicate the availability of Logged MDT WLAN measurements, by means of an indicator, in RRCSetupComplete message or RRCResumeComplete message during connection establishment. Furthermore, the indicator may be included in some uplink RRC messages, i.e., RRCReconfigurationComplete message, RRCReestablishmentComplete message, or UEInformationResponse message, at every transition to RRC Connected mode even though the logging period has not ended.

In certain representative embodiments a WTRU configured to perform Logged MDT Bluetooth measurements may indicate the availability of Logged MDT Bluetooth measurements, by means of an indicator, in RRCSetupComplete message or RRCResumeComplete message during connection establishment. Furthermore, the indicator may be included in some uplink RRC messages, i.e., RRCReconfigurationComplete message, RRCReestablishmentComplete message, or UEInformationResponse message, at every transition to RRC Connected mode even though the logging period has not ended.

An indicator may be also provided in UEInformationResponse message during MDT report retrieval in case the WTRU has not transferred the total log in one RRC message in order to indicate the remaining data availability.

The WTRU may not indicate the availability of MDT measurements in another RAT or in a PLMN that is not in the MDT PLMN list or in a SNPN whose identity is not in the stored SNPN identities.

The network may decide to retrieve the logged measurements based on this indication. In case Logged MDT measurements are retrieved before the completion of the pre-defined logging duration, the reported measurement results may be deleted, but MDT measurement logging may continue according to ongoing logged measurement configuration.

In case the network does not retrieve Logged MDT measurements, WTRU may store non-retrieved measurements for 48 hours from the moment the duration timer for logging expired. There may be no requirement to store non-retrieved data beyond 48 hours. In addition, all logged measurement configuration and the log may be removed by the WTRU at switch off or detach.

In certain representative embodiments, a WTRU may need to perform sensing when the WTRU is not connected for monitoring the environment. When the WTRU needs to report measurements, the WTRU needs to initiate the initial access procedure which consumes battery power. A solution is provided to perform sensing while the WTRU is idle/inactive and store measurements until a condition to report is satisfied.

For performing while idle/inactive state, the logged MDT technology may be applied to logged sensing operation with performing logged sensing measurement (e.g., periodical or event-based) and reporting to a network with various cases: Case #1) WTRU may perform logged sensing measurement (e.g., stationary parking cars) with configured areas (cells) and report later (i.e., which is similar to legacy logged MDT). Case #2) WTRU may perform logged sensing measurement with configured a location/signal (e.g., cell/beams/DL signals) and report when an obstacle is detected immediately.

In case #2 (e.g., intruder/obstacle detection), the network may need to get the logged sensing results immediately for scheduling purpose or needs to report the results to the core network (e.g., entity for sensing function/server).

However, if reusing the logged MDT procedure for logged sensing measurement and reporting, there is no immediate reporting procedure (or event). Hence a network may know the logged sensing availability from WTRU upon reception of MSG5 (e.g., logMeasAvailable) after an RRC connection (resumption) is triggered. Moreover, subsequent actual sensing measurement results may be received via RRC message (e.g., WTRU information response) after RACH procedure is completed. In a result, in network's perspective, the reported sensing results with an immediate request may be out-dated (e.g., obstacle is moving) due to the latency of reporting procedure.

In certain representative embodiments, for a logged sensing operation during idle/inactive state, how to report the sensing results or obstacle detection immediately based on sensing services during performing logged sensing is provided.

In certain representative embodiments, configuration/triggering condition are provided for configuring a WTRU.

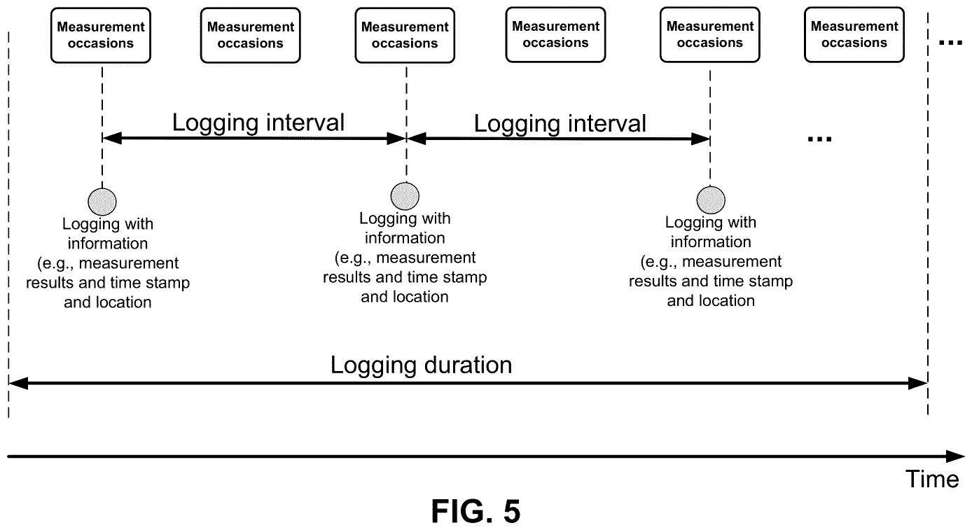

FIG. 5 illustrates an example of logged sensing measurement according to one or more embodiments. A WTRU may perform logging measurement based on the logging interval periodically (e.g., event-based, if configured) during the logging duration. The WTRU may perform measurements at measurement occasions and log at least one of a measurement results, time stamp, or location at logging interval. The WTRU may perform the measurement occasions and the logging the measurement result during the logging duration.

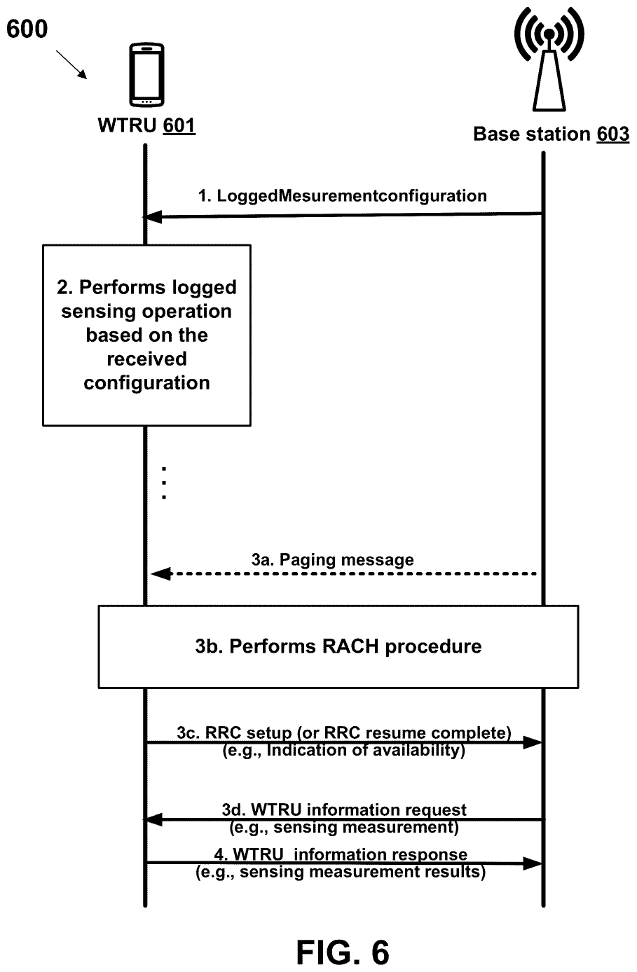

FIG. 6 illustrates a procedure 600 for reporting logged sensing measurements according to one or more embodiments. A base station 603 may transmit a LoggedMesurementconfiguration request to A WTRU 601 at step 1. In response, the WTRU 601 may perform a logged sensing task at step 2. The WTRU 601 may report (for example at step 4) sensing measurement results to the base station 603 after an RRC connection (resumption) is triggered and a RACH procedure is completed (for example, at steps 3a-3d). The WTRU 601 may be similar to any of the WTRUS 102 of FIGS. 1A-1D

In certain representative embodiments, a procedure for receiving logged sensing measurement configuration and conditions for reporting is provided.

In certain representative embodiments, a procedure for reporting of logged sensing measurement results is provided.

In certain representative embodiments, a WTRU may receive a list of configurations of logged sensing measurement and reporting conditions.

In certain representative embodiments, the WTRU may determine to trigger reporting if at least the associated frequencies and/or DL signal(s) is below a threshold, and the WTRU may transmit an availability and report the logged measurement results.

In certain representative embodiments, the WTRU may determine to trigger reporting if the current time elapsed the time window, transmit an availability and report a history of logged sensing measurement results based on the time window.

In certain representative embodiments, the WTRU may determine to trigger reporting if a sensing measurement reporting request is received.

In certain representative embodiments, a WTRU may be configured with multiple configurations of logged sensing measurements and associated reporting conditions. Upon satisfying the conditions, the WTRU may determine to perform reporting an obstacle detection and/or logged sensing measurement results.

In certain representative embodiments, the WTRU may take at least one of the following actions/steps: the WTRU may receive a list of logged sensing configurations from network; The WTRU may receive a first logged sensing configuration (e.g., semi-static sensing) that may include measurement configurations and reporting conditions including at least one of: valid areas (e.g., cells) and/or frequencies and/or associated DL signal(s) (e.g., SSB, DL-RS) and/or time duration, measurement configurations including at least one of a time window (e.g., periodicity, duration) reference timing for start of the time window (e.g., indicated SSB index); triggering reporting condition(s). (e.g., upon RRC setup and/or timer-based) including at least one of a threshold(s) of DL-RSRP of the associated DL signal(s), time window comprising time duration (e.g., number of logging periods and/or msec/sec values).

The WTRU may receive a second logged sensing configuration (e.g., dynamic sensing) that may include measurement configurations and reporting conditions including at least one of valid target object(s)/location(s) and associated DL signal(s) and/or time duration, triggering reporting condition(s) (e.g., immediate and/or timer-based) including at least one of threshold(s) of DL-RSRP of the associated DL signal(s) and associated with UL signals (e.g., dedicated RACH preamble, additional RACH occasion, SR, CG, UCI); time window comprising time duration (e.g., number of logging periods and/or msec/sec values).

Upon receiving the list of logged sensing configurations, the WTRU may initiate one or more logged sensing measurement based on the received sensing configurations (e.g., time window is activated if configured).

While performing the logged sensing measurement, the WTRU may determine to trigger reporting if at least one of the conditions is satisfied: upon satisfying the reporting condition(s) associated with the first sensing configuration including at least one of: if at least the associated frequencies and/or DL signal(s) is below the threshold: Transmit an availability indication and report the logged measurement results. If the time elapsed the duration of time window: Transmit an availability and subsequent logged sensing measurement results based on the time window.

Upon satisfying the reporting condition(s) associated with the second sensing configuration:

If at least the associated DL signal(s) is below than the threshold: Transmit an indication (e.g., whether obstacle is detected) via the configured associated UL signals. If the time elapsed the duration of time window: Transmit an availability and subsequent logged sensing measurement results based on the time window.

In certain representative embodiments, if none of the condition is satisfied, the WTRU may continue performing the logged sensing measurement.

In certain representative embodiments, a WTRU may indicate obstacle detection or report logged sensing measurement results based on the configuration of reporting conditions (e.g., threshold of DL signal and/or timer and/or location). The WTRU may indicate the obstacle detection immediately or logged sensing measurement results with the logging period.

Throughout this disclosure, the term network may be used interchangeably AMF, LMF, LMF-like, gNB, eNB or NG-RAN or core network.

An LMF may be a non-limiting example of a node or entity (e.g., network node or entity) that may be used for or to support positioning or sensing. Any other node or entity may be substituted for LMF (or like-LMF) and still be consistent with this disclosure.

Throughout this disclosure, the term WTRU is used interchangeably with sensing WTRU, activated sensing WTRU or a WTRU with sensing measurement and reporting capabilities.

Throughout this disclosure, the term logged sensing may imply collecting sensing measurement results or storing sensing measurement results.

In certain representative embodiments, Reference Signal time difference (RSTD) may be defined by the difference in time of arrival between PRSs transmitted from a reference TRP and target TRP. The WTRU may be configured with the reference TRP index and target TRP index. The WTRU may be configured with the PRS resource indices to make measurements. The WTRU may determine the time of arrival from TRP based on one or more PRS resources associated with the TRP. In some embodiments, the RSTD may be defined as the difference in time of arrival between the reference PRS transmitted from a TRP and the target PRS transmitted from a TRP.

In some embodiments, “WTRU Rx-Tx time difference” may refer to the difference between arrival time of the reference signal transmitted by the TRP and transmission time of the reference signal transmitted from the WTRU. The WTRU Rx-Tx time difference may be associated with PRS resource ID and/or SRSp resource ID.

In certain representative embodiments, RS Carrier Phase (RSCP) may be defined as the carrier phase measurement on the PRS. RSCP Difference (RSCPD) may be defined as difference in carrier phase measurements between two PRS resources.

In certain representative embodiments, RSRP per path may be defined as the RSRP per path if the WTRU observers a multipath channel in the measurement. The WTRU may determine RSRP for a DL RS resource. RSRP or RSRPP may be reported using units dBm or relative power difference compared to a reference, e.g., RSRP of the first path, in dB.

In certain representative embodiments, measurement may be a channel impulse response. A channel impulse response, consisting of N paths, may be defined by the following equation

$$h ( t ) = {\sum }_{k = 1}^{N} {h}_{k} ( t ) δ ( t - {τ}_{k} )$$

where hₖ(t) and τₖ are time-varying complex valued coefficient (e.g., expressed by a+bj where j=\sqrt{−1} for the channel impulse response and delay, measured in seconds, for the k^{th}path, respectively. The delta function is defined as δ(t)=1 for t=0 and δ(t)=0 for t≠0.

For a sake of simplicity, the coefficients may be constant over time, e.g., g hₖ(t)=hₖ. The WTRU may report hₖ and τₖ for each path k to the network. The WTRU may report the number of paths, N, to the network. Alternatively, the WTRU may receive hₖ and τₖ for each path k from the network and/or the number of paths.

In certain representative embodiments, the WTRU may obtain Channel Impulse Response (CIR) from the network. The network may indicate PRS configuration(s) such as PRS resource IDs associated with the CIR. For example, the CIR may be associated with PRS resource ID. In this case, the WTRU may determine that the CIR is derived based on the measurements made on the PRS resource associated with the ID. Alternatively, the WTRU may determine that the channel along the direction of transmission of the PRS or reception of the PRS corresponds to the CIR.

In certain representative embodiments, the CIR may be associated with a TRP ID. In this case, the WTRU may determine that the CIR represents the channel between the associated TRP and WTRU. In some embodiments, the CIR may be associated with more than one TRPs where the network may include TRP indices associated with the CIR.

In certain representative embodiments, the CIR may be associated with a cell. In this case, the WTRU may receive cell ID or index associated with the CIR from the network.

In certain representative embodiments, CIR may be associated with more than one TRPs or PRS resource IDs. In this case, the WTRU may determine that the channel between the TRPs and the WTRU may correspond to the CIR. Alternatively, the WTRU may determine that the channel along the transmission directions of PRSs associated with IDs or reception directions of the PRS correspond to the CIR.

In certain representative embodiments, more than one CIRs may be associated with one parameter from PRS configurations (e.g., TRP ID, PRS resource ID, frequency layer ID). For example, the WTRU may receive information related to 2 CIRs associated with a TRP from the network, e.g.,

$${h}_{1} ( t ) = {\sum }_{k = 1}^{{N}_{1}} {h}_{1 , k} ( t ) δ ( t - {τ}_{1 , k} ) and {h}_{2} ( t ) = {\sum }_{k = 1}^{{N}_{2}} {h}_{2 , k} ( t ) δ ( t - {τ}_{2 , k} )$$

from the network. Alternatively, the WTRU may report information related to more than one CIRs associated with PRS configuration (e.g., TRP ID, PRS resource ID) based on the measurements to the network. There can be more than one CIRs associated with PRS configuration since the WTRU or network may observe different channel characteristics based on Angle of Arrival (AoA) of DL RS or UL RS, for example.

Channel impulse response may be represented by delay profile or power delay profile. A power delay profile may be defined as a set of delays and power profiles, such as [τ₀, τ₁, . . . , τ_{N-1}] and [p₀, p₁, . . . , p_{N-1}], where pₖ may corresponds to relative power at the k^{th} path compared to the first path. A delay profile may be defined as a set of delays [τ₀, τ₁, . . . , τ_{N-1}] which indicates path delay for each path above p_{threshold}. The WTRU may receive p_{threshold} from the network to derive delay profile from power delay profile.

In certain representative embodiments, the WTRU may receive an indication from the network on how to generate CIR, PDP or DP based on timing, phase and/or power measurements. In one example, the WTRU may send a request to the network to receive an indication on which methodologies to use to generate CIR, PDP or DP based on the measurements the WTRU made. For example, the WTRU may receive a message from the network (e.g., via LTE Positioning Protocol (LPP), RRC, Medium Access Control Control Element (MAC-CE), Downlink Control Information (DCI)) indicating the PRS resource indices and associated measurement type(s) (e.g., RSTD, AOA) to use to generate CIR, Power Delay Profile (PDP) or Delay Profile (DP). In one example, the WTRU may receive an indication from the network indicating to generate CIR, PDP or DP.

In certain representative embodiments, the WTRU may receive a threshold (e.g., power threshold) from the network and timing range (e.g., 0 μs to 1 μs), timing granularity (e.g., every 0.1 us in the indicated timing range, 100 sample points in the indicated timing range) of CIR, PDP and/or DP. In this case, the WTRU may determine to report power and timing (e.g., relative timing compared to a reference timing, absolute timing) any samples whose received power is over the threshold.

The WTRU may send measurements in a report to the network (e.g., LMF, gNB) via a semi-static (e.g., LPP, RRC) or dynamic message (e.g., UCI, UL MAC-CE).

In certain representative embodiments, “PRS”, DL-RS (e.g., CSI-RS, DM-RS, TRS) and SSB may be used interchangeably.

In certain representative embodiments, a WTRU may be configured with one or more logged sensing configurations and/or associated reporting conditions and/or events of reporting (e.g., based on a threshold and/or time window/duration) from base station and/or core network (e.g., new entity with supporting sensing function or LMF). In one example, the sensing configuration may be configured to one or more WTRUs via NAS signaling between WTRU and core network. In some embodiments, the sensing configuration may be configured to one or more WTRUs via signaling between WTRU and base station.

In certain representative embodiments, after performing sensing operation (e.g., logged sensing) based on event-based/periodically, a WTRU may report one or more sensing results to a base station and/or core network entity via request-based and/or signaling-based and/or triggering conditions.

In certain representative embodiments, a base station may transmit a message (e.g., sensing configurations/parameters with including conditions for reporting) to the WTRUs via SIB and/or RRC dedicated message.

In certain representative embodiments, each of the sensing configuration may comprise associated DL signals with one or more threshold(s) and/or UL resource (e.g., reporting of sensing results) and/or associated with a periodicity (e.g., when to report sensing results) and/or reporting conditions. In some embodiments, DL signal(s) is associated with at least frequency/a range of resource block(s)/BWP. For example, the DL signal may include at least one of the DL signals, e.g., SS/PBCH/SSB/SSS. In some embodiments, a WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during sensing operation.

In certain representative embodiments, each of the DL signals may be associated with one or more thresholds. In some embodiments, the threshold may be associated with one of measure values e.g., SSB-RSRP and/or SSB-RSRQ and/or SSB-SINR and/or SS-RSRP and/or SS-RSRQ and/or SS-SINR. In some embodiments, each of the threshold of the DL signal may be associated with an obstacle detection (dynamic detection) and/or building detection (semi-static detection). In some embodiments, when the measured value is below than a threshold (during a certain duration time), the WTRU may determine an obstacle is detected and determine to report the measured sensing results to the network.

In certain representative embodiments, when the WTRU determined that there is an obstacle, the WTRU may indicate, to the network, the presence of an obstacle by using a flag (e.g., 1 for presence of an obstacle, 0 for no presence). The WTRU may report DL signals (e.g., SSB, DL-RS) used to determine the presence of an obstacle by indicating SSB or DL RS resource ID(s) or index (cs). The WTRU may receive a request from the network to report DL-RSs or SSBs used to detect the obstacle.

In certain representative embodiments, each of the DL signals may be associated with at least a measuring time with time window (e.g., number of logging interval, logging duration, duration of slot(s)/subframe(s) and/or periodicity of duration/active time/outside active time). In some embodiments, the measuring time of DL signal(s) may be configured based on the each of the sensing configuration.

In certain representative embodiments, a WTRU may be configured with one or more UL grants for logged sensing measurement reporting and an indication (e.g., whether obstacle being detected or not). The sensing measurement results may comprise one or more sensing L1/L2/L3 measurement results and/or sensing measurement results with location information and/or an indication for indicating an obstacle is detected.

In certain representative embodiments, the WTRU may indicate one or more obstacles being detected with a dedicated RACH preamble and/or an additional RACH occasions and/or SR and/or configured grant and/or UCI. In some embodiments, the WTRU may send the indication via early indication method (e.g., MSG1 and/or MSG3). Each of the RACH preamble/occasion and/or indication for UL may associate with one or more (pre-) configured DL signal(s) and/or locations. In some embodiments, the RACH preamble may be configured/dedicated for 2-step (or 4-step) RACH procedure. In some embodiments, once WTRU may send a RACH preamble via one of the additional RACH occasions, the network may determine an obstacle is detected (i.e., implicitly) in the (pre-) configured cell/area. In some embodiments, the WTRU may send the indication via the SR and/or UCI. For example, the indication may be delivered with piggybacking manner (e.g., with another UL data/control information) when the WTRU send via UL within the UL transmission (e.g., SR and/or UCI and/or UL MAC CE and/or UL grant). In some embodiments, the WTRU may send the indication via SDT (e.g., configured UL grant).

In certain representative embodiments, a WTRU may be configured one or more conditions for logged sensing measurement results reporting. A WTRU may be configured with one or more reporting conditions from base station and/or core network (e.g., new entity with supporting sensing function or LMF).

In certain representative embodiments, a base station may transmit a message (e.g., logged sensing configurations/parameters with including reporting conditions) to the WTRUs via SIB and/or RRC dedicated message. In some embodiments, a WTRU may perform sensing operation upon receiving sensing configuration. In some embodiments, the WTRU may active the sensing operation upon receiving an indication of sensing activation, e.g., DCI/MAC CE. The indication may indicate and active one (e.g., first and/or second) logged sensing configuration among the configured logged sensing configurations.

In certain representative embodiments, the WTRU may receive a message or request (e.g., SIB, RRC dedicated message) to log indicated measurements (e.g., power, timing, phase, CIR, PDP). The WTRU may receive, from the network (e.g., LMF, gNB), the maximum number of multipaths to measure. The WTRU may receive DL-RS configurations or indication of which broadcast signals (e.g., SSB indices) to make measurements. In some embodiments, the WTRU may receive configurations for a reference signal and target reference signal based on which the WTRU measures RSTD. The WTRU may determine which types of measurements (e.g., power, timing, phase) to make based on the WTRU capability, or WTRU condition (e.g., WTRU location, RSRP of SSB). In some embodiments, the WTRU may be configured with zone(s) where each zone is associated with type(s) of measurements. Based on the WTRU location, the WTRU may determine which zone the WTRU is located in, and determines type(s) of measurements the WTRU make. In some embodiments, the WTRU may be configured with a RSRP threshold. The WTRU may determine to make timing measurements on the SSB if its RSRP is greater than the threshold.

In certain representative embodiments, while performing logged sensing operation (or upon receiving the sensing configurations) with first or second logged sensing configuration, a WTRU may determine to report the logged sensing measurement based on conditions (i.e., at least one of the conditions is satisfied).

In certain representative embodiments, the core network (e.g., like-LMF or LMF) may transmit a (Non-Access Stratum) NAS message (e.g., triggering reporting results, provide logged reporting conditions with time window or timer). In some embodiments, the WTRU may trigger and report the logged sensing measurement results to core network upon receiving the NAS signaling.

In certain representative embodiments, the reporting may be based on a factor such as at least one of RSRP, energy, time, or location.

RSRP-based: In some embodiments, a WTRU may be configured with the logged sensing configuration (e.g., first/second) with threshold(s). In some embodiments, the configured/specified DL signal(s) may indicate/be associated with at least one of DL signals (e.g., SSB index, DL reference, CSI-RS, PTRS, PRS, TRS). In some embodiments, DL-RSRLP value may be associated with first/second sensing configuration, the WTRU may determine to perform sensing measurement reporting if the measured value of DL signal is below than the threshold of DL-RSRP.

Energy-based: In some embodiments, a WTRU may be configured with a threshold for an energy level each of the sensing configuration (e.g., first/second). In some embodiments, when the current energy level of the device is above than the first threshold, the WTRU may keep performing logged sensing operation. In some embodiments, when the current energy, power or battery power level of the device is below than the first threshold, the WTRU may determine to report sensing measurement results.

Timer-based: In some embodiments, a WTRU may be configured with a timer and/or time-window. The time value may comprise a number of logging periodical (or event-based) periods and/or msec/secs. In some embodiments, the WTRU may start the timer upon receiving the logged sensing configuration. In some embodiments, the WTRU may start/activate the timer upon receiving the DL signal of activation of timer value or timer-window. In some embodiments, a WTRU may be configured with a time-window associated with one or more DL signals (e.g., periodic SSB/DL-RS). Upon receiving the DL signal, the WTRU may determine the time-window or timer value is expired. In some embodiments, a WTRU may repot when timer or time-window is expired. For example, the WTRU may report logged sensing measurement results based on the time-window. In some embodiments, the WTRU may filter out the up-to-date logged sensing measurement results associated value of time-window, among the whole logged sensing measurement results. In some embodiments, the WTRU may filter/select up-to-date logged sensing measurement results associated value of time-window upon receiving a request (e.g., reporting with up-to-date results based on time-window value) from a network. In some embodiments, a WTRU may determine to report (or based on a network request) the logged sensing measurement results via NAS signaling when the timer window (for NAS layer) or time value is expired. In some embodiments, a WTRU may determine to report (or based on a network request) the logged sensing measurement results via AS signaling when the timer window (for AS layer) or time value is expired.

Location-based: In some embodiments, a WTRU may be (pre-) configured with one or more geographical locations. The location is associated with specific DL signal(s)/cell(s)/cell IDs/PLMN ID/zone/tracking area/geographical coordination/absolute (relative) positioning information. In some embodiments, the WTRU determine to the current location based on RAT dependent (e.g., DL-TDOA) and/or RAT independent positioning techniques. The WTRU may trigger reporting logged sensing measurement results with positioning techniques (or based on the estimated positions). The WTRU may receive positioning related configurations (e.g., DL-RS, positioning method to use) from the network (e.g., LMF). In some embodiments, when a WTRU stays within the configured location(s), the WTRU may not trigger reporting the logged sensing measurement results and then the WTRU may keep performing logged sensing. For example, the WTRU may report the logged sensing measurement results (e.g., event-based measurement reporting) when the WTRU moves out of the location due to handover and/or cell reselection. For example, the WTRU may report all the logged sensing measurement results and/or the WTRU may report the logged sensing measurement results associated specific (pre-configured) location. In some embodiments, when a WTRU stays in the out of the configured locations, the WTRU may keep performing logged sensing measurement. For example, the WTRU may report the logged sensing measurement results (e.g., event-based measurement reporting). Once the WTRU moves within the configured location due to handover and/or cell reselection. For example, the WTRU may report all the logged sensing measurement results and/or the WTRU may report the logged sensing measurement results associated specific (pre-configured) location.

Combinations of the above factors may also be possible: One or another condition being satisfied, multiple conditions being satisfied, a threshold for one condition being computed by another factor, etc.

In certain representative embodiments, a WTRU may be configured to report the sensing measurements results with optimized format (e.g., reduced size and/or signaling). The WTRU may be configured with the optimized reporting when at least one of the conditions are satisfied. In some embodiments, the energy level of the WTRU is below than a (pre-) configured threshold and/or the amount of logged measurement results is above a (pre-) configured. For example, UL data activity (e.g., data rate) is above a (pre-) configured.

In certain representative embodiments, a WTRU may report the logged sensing measurement results in a simplified format (e.g., bitmap and/or codepoint). For example, each of the bit/code is associated with a location/cell/zone. This association is (pre-) configured by network.

In certain representative embodiments, the WTRU may report a bit map, e.g., 1010. The first “1” may indicate the obstacle is detected in the specific first location. The second “0” may indicate the obstacle is not detected in the second location. The third “1” may indicate the obstacle is detected in the specific third location. The second “0” may indicate the obstacle is not detected in the fourth location.

In certain representative embodiments, a WTRU may report the simplified sensing measurement in UL indication (e.g., UCI and/or new MAC CE and/or SR and/or BSR) and/or UL RRC messages (e.g., MSG 3/5). For example, the WTRU may report the simplified sensing result with piggybacking manner in the UL indication and/or UL RRC messages.

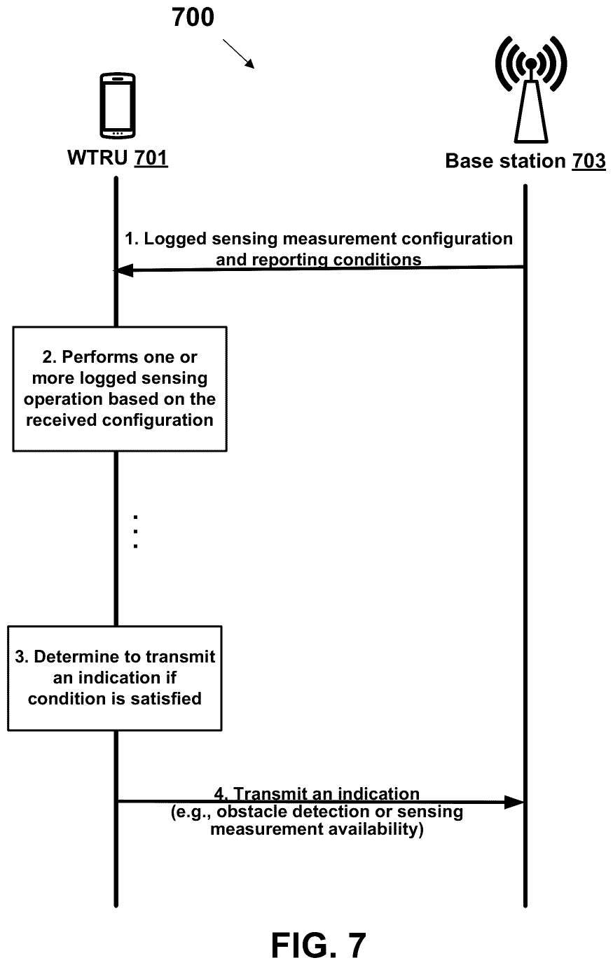

FIG. 7 illustrates a logged sensing measurement and reporting procedure 700 based on conditions according to one or more embodiments. AWTRU 701 may receive logged sensing configuration and associated reporting conditions from a base station 703 (i.e. a network) at step 1. The WTRU 701 may be similar to any of the WTRUs 102 of FIGS. 1A-1D. Upon receiving the logged sensing configuration, the WTRU 703 may initiate sensing operation based on the received sensing configuration at step 2. As an example, the WTRU 703 may measure indicated DL signal(s) while performing logged sensing measurement.

In some embodiments, while performing logged sensing operation, the WTRU 701 may determine to transmit an indication to the network 703 when a reporting condition is satisfied at step 3. The reporting condition may comprise a threshold of DL-RSRP and/or energy level and/or timer window (timer) and/or location.

In some embodiments, the WTRU 701 may transmit an indication of an obstacle being detected or an availability of sensing measurement results at step 4. Upon transmitting the indication, the WTRU 701 may send subsequent logged sensing measurement results to a network.

In certain representative embodiments, a WTRU may be configured with multiple configurations of logged sensing measurement and reporting. Upon receiving a request from network, the WTRU may determine to report an obstacle detection and/or logged sensing measurement results.

The WTRU may take at least one of the actions/steps in the following paragraphs.

The WTRU may receive a logged sensing configurations from network. A first logged sensing configuration (e.g., semi-static sensing) may include measurement configurations and reporting including at least one of: valid areas (e.g., cells) and/or frequencies and/or associated DL signal(s) (e.g., SSB, DL-RS) and/or time duration; Measurement configurations: reference timing for start of the time window (e.g., indicated SSB index), threshold(s) of DL-RSRP of the associated DL signal(s); triggering sensing reporting with network request: upon receiving one or more DL signals (e.g., RRC message (e.g., SIB) and/or NAS signal(s).

A second logged sensing configuration (e.g., dynamic sensing) includes measurement configurations and reporting including at least one of: valid target object(s)/location(s) and associated DL signal(s) and/or time duration; triggering sensing reporting with network request, upon receiving one or more DL signals (e.g., associated/specific SSB and/or DL-RS and/or DCI and/or DL indication) and/or RRC message (e.g., SIB) and/or NAS signal(s), each of the associated DL signal(s) and associated with at least one UL signal (e.g., dedicated RACH preamble, additional RACH occasion, SR, CG, UCI).

Upon receiving the list of sensing configurations, the WTRU may initiate one or more logged sensing measurement based on the received sensing configurations.

While performing the logged sensing measurement, the WTRU may determine to triggers sensing reporting at least based on receiving a sensing reporting request: upon receiving a sensing reporting request associated the first sensing configuration: if at least the associated frequencies and/or DL signal(s) is below than the threshold: the WTRU may transmit an availability and report the logged sensing measurement results.

Upon receiving a sensing report request associated with the second sensing configuration: if at least the associated DL signal(s) is below than the threshold: the WTRU may transmit an indication (e.g., whether obstacle is detected) via the one of the configured associated UL signals.

In other case (i.e., no condition is satisfied), performing the logged sensing measurement.

In certain representative embodiments, a WTRU may indicate obstacle detection immediately or report sensing measurement results based on the request from network. The network may collect the sensing measurement results when it is needed.

In certain representative embodiments, a base station may send a logged sensing reporting request to one or more WTRUs. In some embodiments, a base station may transmit a request message (e.g., DL signal) to the WTRUs via SIB and/or RRC dedicated message and/or via NAS signalling. In some embodiments, the request may comprise, e.g., associated/specific SSB and/or DL-RS and/or DCI and/or DL indication. In some embodiments, the request may comprise an indication of triggering reporting with time value, e.g., msec/sec/period. In some embodiments, the request may comprise/include a specific location of triggering reporting with location, e.g., specific DL signal(s)/cell IDs/PLMN ID(s) intra (inter) frequencies/a specific location/zone/tracking area/geographical coordination/absolute (relative) positioning information. In some embodiments, the request may comprise/include an (explicit) indication of triggering reporting with first logged sensing measurement results (e.g., semi-static sensing) with first sensing configuration and/or reporting with second logged sensing measurement results (e.g., dynamic sensing) with second sensing configuration.

In certain representative embodiments, the WTRU may receive a request from the network to report measurements periodically. In some embodiments, the WTRU may receive a request from the network to report one time only. Depending on the periodicity of the report, the WTRU may determine to initiate initial access procedure to transition into RRC_CONNECTED state. In some embodiments, if the WTRU receives a request to make periodic measurement report, the WTRU may determine to start the initial access procedure.

In certain representative embodiments, the WTRU may receive an indication from the network to report detection of an object or measurements. Depending on the report content (e.g., detection, measurements) requested by the network, the WTRU may determine the method to report. In some embodiments, the WTRU may determine to use msg1 or msg3 to report whether an obstacle or object is present or not. In some embodiments, if the WTRU receives a request to report measurements, the WTRU may determine to use SDT (Small Data Transmission) or transition into RRC_CONNECTED using the initial access.

In certain representative embodiments, a WTRU may be configured with a timer and/or time-window. The time value may comprise a number of logging periodical (or event-based) periods and/or msec/secs. In some embodiments, the WTRU may start the timer upon receiving the logged sensing configuration. In some embodiments, the WTRU may start/activate the timer upon receiving the DL signal of activation of timer value or timer-window. In some embodiments, a WTRU may be configured with a time-window associated with one or more DL signals (e.g., periodic SSB/DL-RS). Upon receiving the DL signal, the WTRU may determine the time-window or timer value is expired.

In certain representative embodiments, a timestamp be indicated by absolute time, relative time (e.g., in seconds) compared to a reference time, SFN, slot index, frame index, subframe index and/or symbol index. Examples of “absolute time” may be UTC time, GNSS time, locally defined absolute time (e.g., LTE or NR Time).

In certain representative embodiments, the WTRU may receive or determine configurations for a time-window such as duration (e.g., expressed in terms of seconds, number of symbols, number of slots, number of frames, number of subframes), start and/or end time (e.g., expressed in terms of absolute time, system time, relative time with respect to a reference time indicated by the network or determined by the WTRU, SNF index, slot index, symbol index, frame index, subframe index). The WTRU may receive more than one configurations of a time-window where each configuration is associated with an index.

In certain representative embodiments, configuration for a time window may include periodicity, start and/or end time. The WTRU may determine the start time based on an event (e.g., when the WTRU is released to IDLE, INACTIVE mode), when the WTRU receives an indicated SSB or SSB associated with the time window.

In certain representative embodiments, the WTRU may determine to make configured measurements during the time window. The WTRU may receive an indication which DL-RSs or broadcast signals to measure. The WTRU may receive an indication the measurement type the WTRU should make (e.g., timing, power, phase). The WTRU may make measurements on DL signals if duration of the DL signals goes over the boundary of the time window.

In certain representative embodiments, the WTRU may make measurements over more than one time instances during a time window. The WTRU may indicate to the network in the measurement report that each measurement corresponds to each measurement instance or the reported measurement is the result of processing measurements over more than one time instances. Examples of processing is averaging, for example.

In certain representative embodiments, a WTRU may report when timer or time-window is expired. In some embodiments, the WTRU may report logged sensing measurement results based on the time-window. In some embodiments, the WTRU may filter out the up-to-date logged sensing measurement results associated value of time-window, among the whole logged sensing measurement results. In some embodiments, the WTRU may filter/select up-to-date logged sensing measurement results associated value of time-window upon receiving a request (e.g., reporting with up-to-date results based on time-window value) from a network.

In certain representative embodiments, a WTRU may determine to report the logged sensing measurement results based on a network request via NAS signaling when the timer window (for NAS layer) or time value is expired. In some embodiments, a WTRU may determine to report the logged sensing measurement results based on a network request via AS signaling when the timer window (for AS layer) or time value is expired.

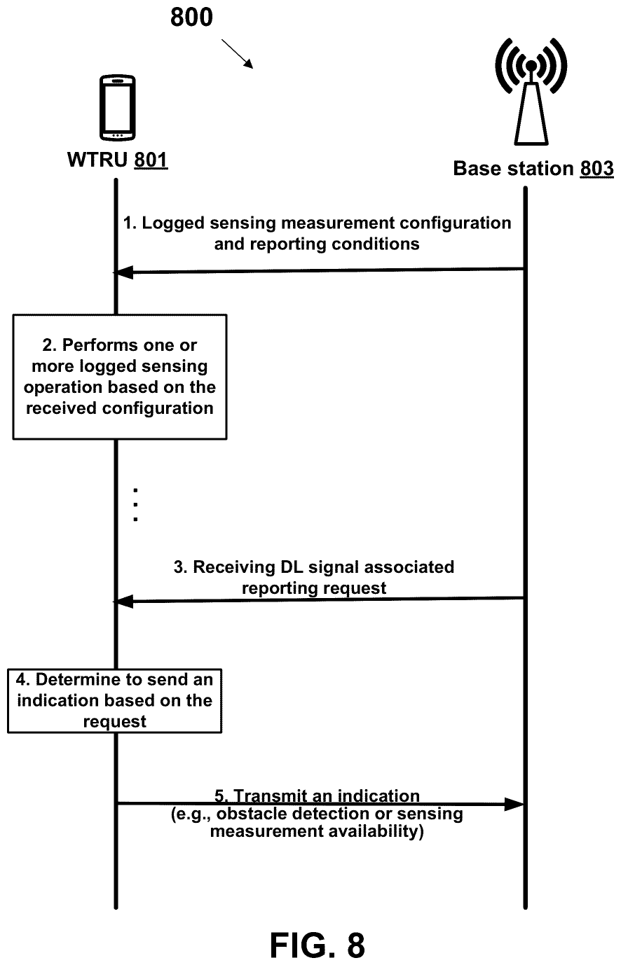

FIG. 8 illustrates a logged sensing measurement and reporting procedure 800 based on a network 803 request according to one or more embodiments. AWTRU 801 may receive logged sensing configuration and associated DL signals associated a reporting request from a base station 803 (i.e. a network) at step 1. The WTRU 801 may be similar to any of the WTRUs 102 of FIGS. 1A-ID. Upon receiving the logged sensing configuration, the WTRU 701 may initiate sensing operation based on the received sensing configuration at step 2. The WTRU 801 may measure indicated DL signal(s) while performing logged sensing measurement.

In some embodiments, the WTRU 801 may receive DL signals associated with a reporting request (e.g., SSB and/or DL reference signal) at step 3, while performing logged sensing operation. The WTRU 801 may determine to transmit an indication to the network 803 based on the request at step 4.

In some embodiments, the WTRU 801 may transmit an indication of obstacle being detected or an availability of sensing measurement results at step 5. Upon transmitting the availability, the WTRU 801 may send subsequent logged sensing measurement results to the network 803.

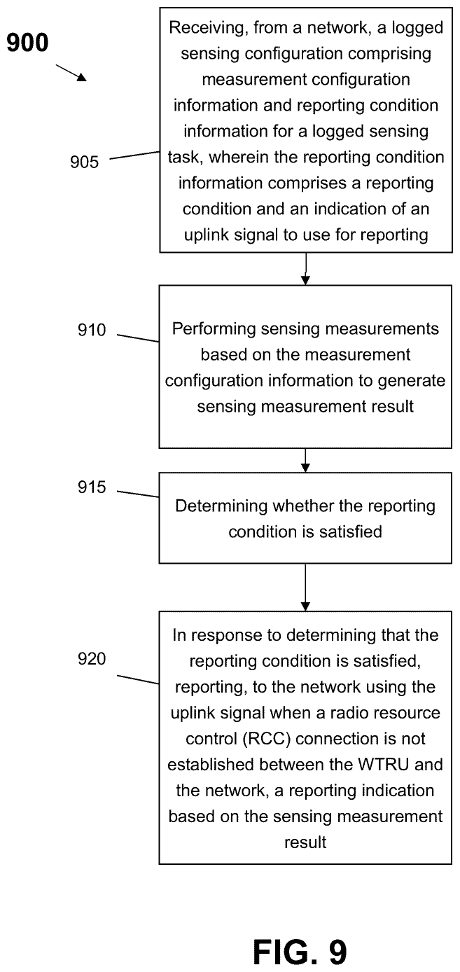

FIG. 9 illustrates a method 900 for reporting logged sensing measurement according to one or more embodiments. The method 900 may be performed by a WTRU such as any of the WTRUs 102 of FIGS. 1A-1D, the WTRU 601 of FIG. 6, the WTRU 701 of FIG. 7, or the WTRU 801 of FIG. 8. The method 900 may include receiving 905, from a network, a logged sensing configuration comprising measurement configuration information and reporting condition information for a logged sensing task, wherein the reporting information comprises a reporting condition and an indication of an uplink signal to use for reporting. In some embodiments, the receiving 905 may correspond to step 1 of FIG. 7 or 8. The method 900 may further include performing 910, sensing measurements based on the measurement configuration information to generate sensing measurement result. In some embodiments, the performing 910 corresponds to step 2 of FIG. 7 or 8. The method 900 may further include, determining 915, whether the reporting condition is satisfied. In some embodiments, the determining 915 corresponds to step 3 of paragraph FIG. 7. The method 900 may further include in response to determining that the reporting condition is satisfied, reporting 920, to the network using the uplink signal when a radio resource control (RCC) connection is not established between the WTRU and the network, a reporting indication based on the sensing measurement result. In some embodiments, the reporting 910 corresponds to step 4 of FIG. 7.

In some embodiments, the measurement configuration information may comprise at least one of: an indication of at least one sensing target object, an indication of at least one sensing location, a downlink signal associated with the logged sensing task, or a periodicity or a time duration associated with the logged sensing task.

In some embodiments, the reporting condition may comprise a threshold associated with a downlink signal and the sensing measurement result may indicate a change in the downlink signal with respect to the threshold. In some embodiments, the method 900 may further comprises detecting at least one obstacle at a sensing location based on the change in the downlink signal.

In some embodiments, the reporting condition may comprise a time duration and the determining whether the reporting condition is satisfied may comprise determining an expiry of time with respect to the time duration.

In some embodiments, the reporting condition may comprise a downlink signal associated with a request of sensing measurement result.

In some embodiments, the determining whether the reporting condition is satisfied may comprise receiving the downlink signal associated with the request of sensing measurement result.

In some embodiments, the reporting indication may comprise at least one of a bit, a bitmap or a codepoint and the at least one of the bit, the bitmap or the codepoint comprises information indicating that at least one sensing target object or at least one obstacle at a sensing location is detected or not detected.

In some embodiments, the uplink signal may be associated with a random access channel, a reference signal, a configured grant, scheduling request, or uplink control Information.

In some embodiments, the measurement configuration information may be a first measurement configuration information and the method 900 may further comprise receiving, from the network, a second logged sensing configuration comprising a second measurement configuration information and a second reporting condition information for the logged sensing task. The second configuration information may be different from the first configuration information.

In some embodiments, the first measurement configuration information may indicate a first time duration for the logged sensing task and the second measurement configuration may indicate a second time duration for the logged sensing task. The second time duration may be longer than the first time duration.

In some embodiments, the method 900 may comprise transmitting, to the network, a first message comprising the reporting indication and a second message comprising subsequently stored sensing measurement results.

In some embodiments, the reporting indication comprises information indicating an availability of the sensing measurement result.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), comprising:
receiving, from a network, a logged sensing configuration comprising measurement configuration information and reporting condition information for a logged sensing task, wherein the reporting condition information comprises a reporting condition and an indication of an uplink signal to use for reporting;
performing sensing measurements based on the measurement configuration information to generate a sensing measurement result; and
in response to determining that the reporting condition is satisfied, reporting, to the network using the uplink signal when a radio resource control (RCC) connection is not established between the WTRU and the network, a reporting indication based on the sensing measurement result.

2. The method of claim 1, wherein the measurement configuration information comprises at least one of: an indication of at least one sensing target object, an indication of at least one sensing location, a downlink signal associated with the logged sensing task, or a periodicity or a time duration associated with the logged sensing task.

3. The method of claim 1, wherein:
the reporting condition comprises a threshold associated with a downlink signal and the sensing measurement result indicates a change in the downlink signal with respect to the threshold; and
the method further comprises detecting at least one obstacle at a sensing location based on the change in the downlink signal.

4. The method of claim 1, wherein:
the reporting condition comprises a time duration; and
determining that the reporting condition is satisfied comprises determining an expiry of time with respect to the time duration.

5. The method of claim 1, wherein the reporting condition comprises a downlink signal associated with a request of sensing measurement result.

6. The method of claim 5, wherein determining that the reporting condition is satisfied comprises receiving the downlink signal associated with the request of sensing measurement result.

7. The method of claim 1, wherein:
the reporting indication comprises at least one of a bit, a bitmap, or a codepoint; and
the at least one of the bit, the bitmap, or the codepoint comprises information indicating that at least one sensing target object or at least one obstacle at a sensing location is detected or not detected.

8. The method of claim 1, wherein the uplink signal is associated with a random access channel, a reference signal, a configured grant, scheduling request, or uplink control Information.

9. The method of claim 1, wherein:
the measurement configuration information is a first measurement configuration information;
the method further comprises receiving, from the network, a second logged sensing configuration comprising a second measurement configuration information and a second reporting condition information for the logged sensing task; and
the second configuration information is different from the first configuration information.

10. The method of claim 9, wherein:
the first measurement configuration information indicates a first time duration for the logged sensing task;
the second measurement configuration indicates a second time duration for the logged sensing task; and
the second time duration is longer than the first time duration.

11. The method of claim 10, further comprising:
transmitting, to the network, a first message comprising the reporting indication and a second message comprising subsequently generated the sensing measurement results.

12. The method of claim 1, wherein the reporting indication comprises information indicating an availability of the sensing measurement result.

13. A wireless transmit/receive unit (WTRU) comprising:
a processer; and
a transceiver, wherein the WTRU is configured to:
receive, from a network, a logged sensing configuration comprising measurement configuration information and reporting information for a logged sensing task, wherein the reporting condition information comprises a reporting condition and an indication of an uplink signal to use for reporting;
perform sensing measurements based on the configuration information to generate a sensing measurement result; and
in response to determining that the reporting condition is satisfied, report, to the network using the uplink signal when a radio resource control (RCC) connection is not established between the WTRU and the network, a reporting indication based on the sensing measurement result.

14. The WTRU of claim 13, wherein the measurement configuration information comprises at least one of: an indication of at least one sensing target object, an indication of at least one sensing location, a downlink signal associated with the logged sensing task, or a periodicity or a time duration associated with the logged sensing task.

15. The WTRU of claim 13, wherein:
the reporting condition comprises a threshold associated with a downlink signal;
the sensing measurement result indicates a change in the downlink signal with respect to the threshold; and
the WTRU is further configured to detect at least one obstacle at a sensing location based on the change in the downlink signal.

16. The WTRU of claim 13, wherein:
the reporting condition comprises a time duration; and
determining that the reporting condition is satisfied comprises determining an expiry of time with respect to the time duration.

17. The WTRU of claim 13, wherein the reporting condition comprises a downlink signal associated with a request of sensing measurement result.

18. The WTRU of claim 17, wherein determining that the reporting condition is satisfied comprises receiving the downlink signal associated with the request of sensing measurement result.

19. The WTRU of claim 13, wherein:
the reporting indication comprises at least one of a bit, a bitmap or a codepoint; and
the at least one of the bit, the bitmap or the codepoint comprises information indicating that at least one sensing target object or at least one obstacle at a sensing location is detected or not detected.

20. The WTRU of claim 13, wherein the uplink signal is associated with a random access channel, a reference signal, a configured grant, scheduling request, or uplink control Information.
